(19) United States
(12) Patent Application Publication
(10) Pub. No.: US 2026/0105562 A1
(43) Pub. Date: Apr. 16, 2026

(54) METHOD AND APPARATUS FOR OVERCOMING BLIND SPOTS IN VIRTUAL REALITY (VR) HEADSET

(71) Applicant: QUALCOMM Incorporated, San Diego, CA (US)

(72) Inventors: Tejaswini SHENOY, Bangalore (IN); Shruti HANUMANTHAIAH, Bangalore (IN); Subbarao LANKA, Bangalore (IN)

(21) Appl. No.: 18/912,269

(22) Filed: Oct. 10, 2024

(51) Int. Cl. G06T 1/20; G06F 3/01

(52) U.S. Cl. CPC G06T 1/20; G06F 3/012

(57) ABSTRACT

A method for a computing method includes detecting a power loss event in a mixed reality head mounted display. The method also includes routing video see through (VST) processing to a dedicated VST hardware block, in response to detecting the power loss event. The dedicated VST hardware block includes a power domain rail that is independent from a power domain of a mixed reality system on chip (SoC).

### FIELD OF THE DISCLOSURE

The present disclosure relates generally to virtual reality (VR), and more specifically to overcoming VR blind spots for power optimized wearable devices, such as mixed reality (MR)/VR headsets or head-mounted displays.

### BACKGROUND

Augmented reality (AR) merges the real world with virtual objects to support realistic, intelligent, and personalized experiences. Conventional augmented reality applications provide a live view of a real-world environment whose elements may be augmented by computer-generated sensory input such as video, sound, graphics, or global positioning system (GPS) data. With such applications, a view of reality may be modified by a computing device, to enhance a user's perception of reality and provide more information about the user's environment. Virtual reality (VR) simulates physical presence in real or imagined worlds, and enables the user to interact in that world. Mixed reality (MR) allows a user to see the real world while interacting with a virtual environment, for example, with video see through (VST) technology. Improving safety for MR, AR, and VR users while wearing MR/AR/VR headsets is desirable.

### SUMMARY

In aspects of the present disclosure, a computing method includes detecting a power loss event in a mixed reality head mounted display. The method also includes routing video see through (VST) processing to a dedicated VST hardware block, in response to detecting the power loss event. The dedicated VST hardware block includes a power domain rail that is independent from a power domain of a mixed reality system on chip (SoC).

Other aspects of the present disclosure are directed to an apparatus. The apparatus has one or more memories and one or more processors coupled to the memory. The processor(s) is configured to detect a power loss event in a mixed reality head mounted display. The processor(s) is also configured to route video see through (VST) processing to a dedicated VST hardware block, in response to detecting the power loss event. The dedicated VST hardware block includes a power domain rail that is independent from a power domain of a mixed reality system on chip (SoC).

This has outlined, rather broadly, the features and technical advantages of the present disclosure in order that the detailed description that follows may be better understood. Additional features and advantages of the present disclosure will be described below. It should be appreciated by those skilled in the art that the present disclosure may be readily utilized as a basis for modifying or designing other structures for carrying out the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF DRAWINGS

The details of one or more examples of the disclosure are set forth in the accompanying drawings and the description below. Other features, objects, and advantages of the disclosure will be apparent from the description and drawings, and from the claims.

FIG. 1 illustrates an example implementation of a system-on-a-chip (SoC).

FIG. 2 is a block diagram that illustrates an example content generation and coding system to implement extended reality (XR) or virtual reality (VR) applications, in accordance with various aspects of the present disclosure.

FIG. 3 is a block diagram illustrating video see through (VST) components, in accordance with various aspects of the present disclosure.

FIG. 4 is a diagram illustrating solution coverage, in accordance with various aspects of the present disclosure.

FIGS. 5A and 5B are block diagrams illustrating integrated and external VST configurations, respectively, in accordance with various aspects of the present disclosure.

FIG. 6 is a block diagram illustrating an integrated video see through (iVST) system for early on VST operation or always on VST operation, in accordance with various aspects of the present disclosure.

FIG. 7 is a block diagram illustrating an external video see through (exVST) system for early on VST operation or always on VST operation, in accordance with various aspects of the present disclosure.

FIG. 8 is a block diagram illustrating a read only memory (ROM) boot loader for iVST and exVST systems operating with an early on VST feature, in accordance with various aspects of the present disclosure.

FIG. 9 is a flow diagram illustrating VST processing for early on VST and always on VST features, in accordance with various aspects of the present disclosure.

FIG. 10 is a flowchart illustrating VST processing, in accordance with various aspects of the present disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings one skilled in the art should appreciate that the scope of this disclosure is intended to cover any aspect of the systems, apparatuses, computer program products, and methods disclosed, whether implemented independently of, or combined with, other aspects of the disclosure. For example, an apparatus may be implemented or a method may be practiced using any number of the aspects set forth. In addition, the scope of the disclosure is intended to cover such an apparatus or method which is practiced using other structure, functionality, or structure and functionality in addition to or other than the various aspects of the disclosure set forth. Any aspect disclosed may be embodied by one or more elements of a claim.

Although various aspects are described, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-a-chip (SoCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described, one or more techniques may refer to an application (e.g., software) being configured to perform one or more functions. In such examples, the application may be stored on a memory (e.g., on-chip memory of a processor, system memory, or any other memory). Hardware described, such as a processor may be configured to execute the application. For example, the application may be described as including code that, when executed by the hardware, causes the hardware to perform one or more techniques described. As an example, the hardware may access the code from a memory and executed the code accessed from the memory to perform one or more techniques described. In some examples, components are identified in this disclosure. In such examples, the components may be hardware, software, or a combination thereof. The components may be separate components or sub-components of a single component.

Accordingly, in one or more examples described, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

The term “content” may refer to graphical content or display content. In some examples, the term “graphical content” may refer to content generated by a processing unit configured to perform graphics processing. For example, the term “graphical content” may refer to content generated by one or more processes of a graphics processing pipeline. In some examples, the term “graphical content” may refer to content generated by a graphics processing unit. In some examples, as used, the term “display content” may refer to content generated by a processing unit configured to perform displaying processing. In some examples, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling (e.g., upscaling or downscaling) on a frame. In some examples, a frame may refer to a layer. In other examples, a frame may refer to two or more layers that have already been blended together to form the frame (e.g., the frame includes two or more layers, and the frame that includes two or more layers may subsequently be blended)

As referenced, a first component (e.g., a processing unit) may provide content, such as graphical content, to a second component (e.g., a content coder). In some examples, the first component may provide content to the second component by storing the content in a memory accessible to the second component. In such examples, the second component may be configured to read the content stored in the memory by the first component. In other examples, the first component may provide content to the second component without any intermediary components (e.g., without memory or another component). In such examples, the first component may be described as providing content directly to the second component. For example, the first component may output the content to the second component, and the second component may be configured to store the content received from the first component in a memory, such as a buffer.

For a mobile device, such as a mobile telephone, a single printed circuit board (PCB) may support multiple components including a CPU, GPU, DSP, etc. For an augmented reality (AR), mixed reality (MR), or virtual reality (VR) device, the components may be located on different PCBs due to the form factor of the AR, MR, or VR device. For example, the AR, MR, or VR device may be in the form of eyeglasses or a head mounted display, also referred to as a headset.

In the case of a virtual reality (VR) headset that covers the user's eyes, the user is blind when the headset is not booted up, or undergoes a system crash, warm reset, or user initiated hard reset. This state of blindness is not suitable in mixed reality use cases and can be dangerously unsafe for the user. For example, a user may wear a VR head set in mixed reality mode with video see through (VST) while walking on the street. In such an example, if the VR device undergoes a crash, warm reset, or user initiated hard reset, the user is blind to the real environment, which can be life threatening. Safety is also an issue when the user decides to first wear the VR device and then subsequently power on the device. Aspects of the present disclosure more quickly enable a camera in the VST display path or allow the camera to be always enabled. The improved camera availability makes the VR headset commercially safe for mixed reality (MR) use cases.

With quick boot solutions, the VST subsystem/pipeline is enabled early in the boot process, for example, within approximately 300 milliseconds (ms) of a system-on-a-chip (SoC) reset or crash. Because the human eye blink time is approximately 300 ms, booting within 300 ms practically eliminates blind time for the VR user, ensuring user safety. With always on (AON) solutions, the VST hardware subsystem always remains on, despite the rest of the system going through a reset. Integrated or external VST solutions can both selectively utilize quick boot or always on (AON) methodologies.

To enable VST quickly, the VST block uses fewer cores. Hence, integrated VST (iVST) and external VST (exVST) solutions propose a separate dedicated hardware block for VST processing. The dedicated VST block can be integrated into a main SoC with the iVST solution. Alternatively, the VST block can be a standalone chip that is separate from the SoC.

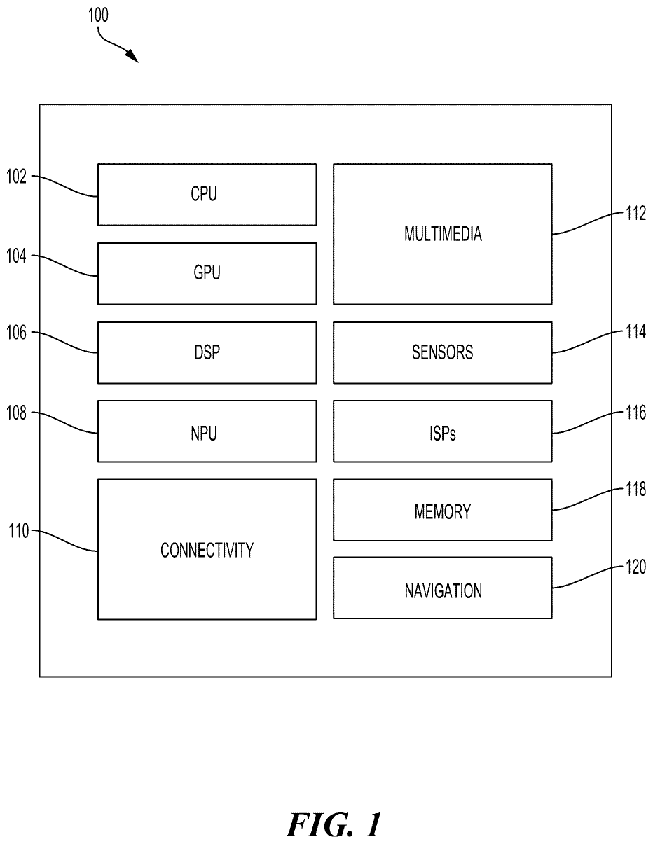

FIG. 1 illustrates an example implementation of a system-on-a-chip (SoC) 100 on a printed circuit board (PCB). The host SoC 100 includes processing blocks tailored to specific functions, such as a connectivity block 110. The connectivity block 110 may include fifth generation (5G) new radio (NR) connectivity, fourth generation long term evolution (4G LTE) connectivity, Wi-Fi connectivity, USB connectivity, Bluetooth® connectivity, Secure Digital (SD) connectivity, and the like.

In this configuration, the SoC 100 includes various processing units that support multi-threaded operation. For the configuration shown in FIG. 1, the SoC 100 includes a multi-core central processing unit (CPU) 102, a graphics processor unit (GPU) 104, a digital signal processor (DSP) 106, and a neural processor unit (NPU) 108. The SoC 100 may also include a sensor processor 114, image signal processors (ISPs) 116, a navigation module 120, which may include a global positioning system, and a memory 118. The multi-core CPU 102, the GPU 104, the DSP 106, the NPU 108, and the multi-media engine 112 support various functions such as video, audio, graphics, extended reality (XR) gaming, artificial networks, and the like. Each processor core of the multi-core CPU 102 may be a reduced instruction set computing (RISC) machine, an advanced RISC machine (ARM), a microprocessor, or some other type of processor. The NPU 108 may be based on an ARM instruction set.

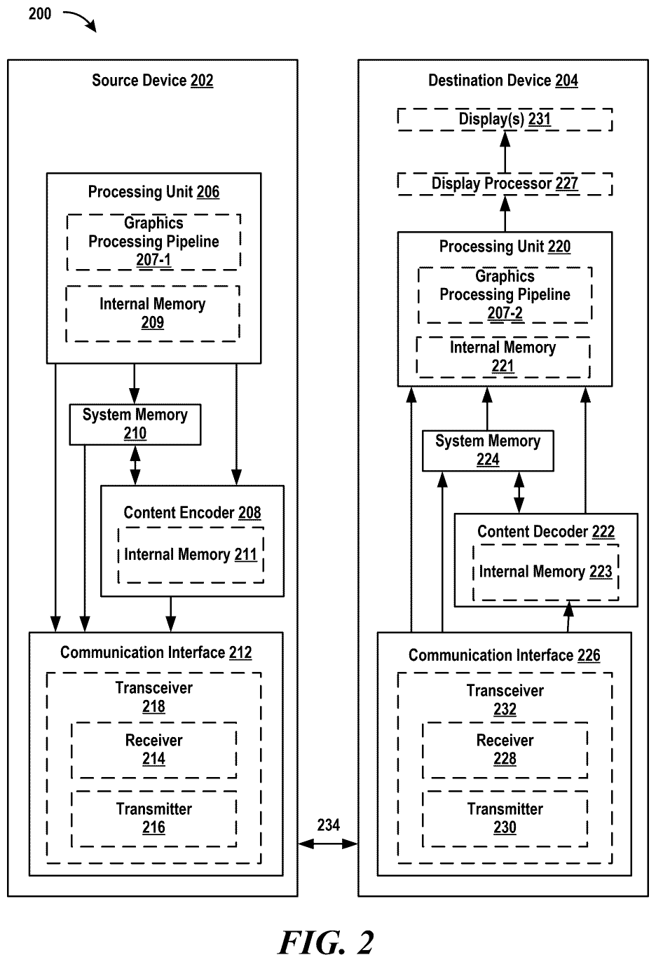

FIG. 2 is a block diagram that illustrates an example extended reality (XR)/mixed reality (MR) or virtual reality (VR) system 200 configured to implement extended reality (XR), MR, or VR applications, according to aspects of the present disclosure. The XR/MR system 200 includes a source device 202 and a destination device 204. In accordance with the techniques described, the source device 202 may be configured to encode, using the content encoder 208, graphical content generated by the processing unit 206 prior to transmission to the destination device 204. The content encoder 208 may be configured to output a bitstream having a bit rate. The processing unit 206 may be configured to control and/or influence the bit rate of the content encoder 208 based on how the processing unit 206 generates graphical content.

The source device 202 may include one or more components (or circuits) for performing various functions described herein. The destination device 204 may include one or more components (or circuits) for performing various functions described. In some examples, one or more components of the source device 202 may be components of a system-on-a-chip (SoC). Similarly, in some examples, one or more components of the destination device 204 may be components of an SoC.

The source device 202 may include one or more components configured to perform one or more techniques of this disclosure. In the example shown, the source device 202 may include a processing unit 206, a content encoder 208, a system memory 210, and a communication interface 212. The processing unit 206 may include an internal memory 209. The processing unit 206 may be configured to perform graphics processing, such as in a graphics processing pipeline 207-1. The content encoder 208 may include an internal memory 211.

Memory external to the processing unit 206 and the content encoder 208, such as system memory 210, may be accessible to the processing unit 206 and the content encoder 208. For example, the processing unit 206 and the content encoder 208 may be configured to read from and/or write to external memory, such as the system memory 210. The processing unit 206 and the content encoder 208 may be communicatively coupled to the system memory 210 over a bus. In some examples, the processing unit 206 and the content encoder 208 may be communicatively coupled to each other over the bus or a different connection.

The content encoder 208 may be configured to receive graphical content from any source, such as the system memory 210 and/or the processing unit 206. The system memory 210 may be configured to store graphical content generated by the processing unit 206. For example, the processing unit 206 may be configured to store graphical content in the system memory 210. The content encoder 208 may be configured to receive graphical content (e.g., from the system memory 210 and/or the processing unit 206) in the form of pixel data. Otherwise described, the content encoder 208 may be configured to receive pixel data of graphical content produced by the processing unit 206. For example, the content encoder 208 may be configured to receive a value for each component (e.g., each color component) of one or more pixels of graphical content. As an example, a pixel in the red, green, blue (RGB) color space may include a first value for the red component, a second value for the green component, and a third value for the blue component.

The internal memory 209, the system memory 210, and/or the internal memory 211 may include one or more volatile or non-volatile memories or storage devices. In some examples, internal memory 209, the system memory 210, and/or the internal memory 211 may include random access memory (RAM), static RAM (SRAM), dynamic RAM (DRAM), erasable programmable ROM (EPROM), electrically erasable programmable ROM (EEPROM), Flash memory, a magnetic data media or an optical storage media, or any other type of memory.

The internal memory 209, the system memory 210, and/or the internal memory 211 may be a non-transitory storage medium according to some examples. The term “non-transitory” may indicate that the storage medium is not embodied in a carrier wave or a propagated signal. However, the term “non-transitory” should not be interpreted to mean that internal memory 209, the system memory 210, and/or the internal memory 211 is non-movable or that its contents are static. As one example, the system memory 210 may be removed from the source device 202 and moved to another device. As another example, the system memory 210 may not be removable from the source device 202.

The processing unit 206 may be a central processing unit (CPU), a graphics processing unit (GPU), a general purpose GPU (GPGPU), or any other processing unit that may be configured to perform graphics processing. In some examples, the processing unit 206 may be integrated into a motherboard of the source device 202. In some examples, the processing unit 206 may be present on a graphics card that is installed in a port in a motherboard of the source device 202, or may be otherwise incorporated within a peripheral device configured to interoperate with the source device 202.

The processing unit 206 may include one or more processors, such as one or more microprocessors, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 206 may store instructions for the software in a suitable, non-transitory computer-readable storage medium (e.g., internal memory 209), and may execute the instructions in hardware using one or more processors to perform the techniques of this disclosure. Any of the foregoing (including hardware, software, a combination of hardware and software, etc.) may be considered to be one or more processors.

The content encoder 208 may be any processing unit configured to perform content encoding. In some examples, the content encoder 208 may be integrated into a motherboard of the source device 202. The content encoder 208 may include one or more processors, such as one or more microprocessors, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the content encoder 208 may store instructions for the software in a suitable, non-transitory computer-readable storage medium (e.g., internal memory 211), and may execute the instructions in hardware using one or more processors to perform the techniques of this disclosure. Any of the foregoing (including hardware, software, a combination of hardware and software, etc.) may be considered to be one or more processors.

The communication interface 212 may include a receiver 214 and a transmitter 216. The receiver 214 may be configured to perform any receiving function described with respect to the source device 202. For example, the receiver 214 may be configured to receive information from the destination device 204, which may include a request for content. In some examples, in response to receiving the request for content, the source device 202 may be configured to perform one or more techniques described, such as produce or otherwise generate graphical content for delivery to the destination device 204. The transmitter 216 may be configured to perform any transmitting function described herein with respect to the source device 202. For example, the transmitter 216 may be configured to transmit encoded content to the destination device 204, such as encoded graphical content produced by the processing unit 206 and the content encoder 208 (e.g., the graphical content is produced by the processing unit 206, which the content encoder 208 receives as input to produce or otherwise generate the encoded graphical content). The receiver 214 and the transmitter 216 may be combined into a transceiver 218. In such examples, the transceiver 218 may be configured to perform any receiving function and/or transmitting function described with respect to the source device 202.

The destination device 204 may include one or more components configured to perform one or more techniques of this disclosure. In the example shown, the destination device 204 may include a processing unit 220, a content decoder 222, a system memory 224, a communication interface 226, and one or more displays 231. Reference to the displays 231 may refer to the one or more displays 231. For example, the displays 231 may include a single display or multiple displays. The displays 231 may include a first display and a second display. The first display may be a left-eye display and the second display may be a right-eye display. In some examples, the first and second display may receive different frames for presentment thereon. In other examples, the first and second display may receive the same frames for presentment thereon.

The processing unit 220 may include an internal memory 221. The processing unit 220 may be configured to perform graphics processing, such as in a graphics processing pipeline 207-2. The content decoder 222 may include an internal memory 223. In some examples, the destination device 204 may include a display processor, such as the display processor 227, to perform one or more display processing techniques on one or more frames generated by the processing unit 220 before presentment by the one or more displays 231. The display processor 227 may be configured to perform display processing. For example, the display processor 227 may be configured to perform one or more display processing techniques on one or more frames generated by the processing unit 220. The one or more displays 231 may be configured to display content that was generated using decoded content. For example, the display processor 227 may be configured to process one or more frames generated by the processing unit 220, where the one or more frames are generated by the processing unit 220 by using decoded content that was derived from encoded content received from the source device 202. In turn the display processor 227 may be configured to perform display processing on the one or more frames generated by the processing unit 220. The one or more displays 231 may be configured to display or otherwise present frames processed by the display processor 227. In some examples, the one or more display devices may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 220 and the content decoder 222, such as system memory 224, may be accessible to the processing unit 220 and the content decoder 222. For example, the processing unit 220 and the content decoder 222 may be configured to read from and/or write to external memory, such as the system memory 224. The processing unit 220 and the content decoder 222 may be communicatively coupled to the system memory 224 over a bus. In some examples, the processing unit 220 and the content decoder 222 may be communicatively coupled to each other over the bus or a different connection.

The content decoder 222 may be configured to receive graphical content from any source, such as the system memory 224 and/or the communication interface 226. The system memory 224 may be configured to store received encoded graphical content, such as encoded graphical content received from the source device 202. The content decoder 222 may be configured to receive encoded graphical content (e.g., from the system memory 224 and/or the communication interface 226) in the form of encoded pixel data. The content decoder 222 may be configured to decode encoded graphical content.

The internal memory 221, the system memory 224, and/or the internal memory 223 may include one or more volatile or non-volatile memories or storage devices. In some examples, internal memory 221, the system memory 224, and/or the internal memory 223 may include random access memory (RAM), static RAM (SRAM), dynamic RAM (DRAM), erasable programmable ROM (EPROM), electrically erasable programmable ROM (EEPROM), Flash memory, a magnetic data media or an optical storage media, or any other type of memory.

The internal memory 221, the system memory 224, and/or the internal memory 223 may be a non-transitory storage medium according to some examples. The term “non-transitory” may indicate that the storage medium is not embodied in a carrier wave or a propagated signal. However, the term “non-transitory” should not be interpreted to mean that internal memory 221, the system memory 224, and/or the internal memory 223 is non-movable or that its contents are static. As one example, the system memory 224 may be removed from the destination device 204 and moved to another device. As another example, the system memory 224 may not be removable from the destination device 204.

The processing unit 220 may be a central processing unit (CPU), a graphics processing unit (GPU), a general purpose GPU (GPGPU), or any other processing unit that may be configured to perform graphics processing. In some examples, the processing unit 220 may be integrated into a motherboard of the destination device 204. In some examples, the processing unit 220 may be present on a graphics card that is installed in a port in a motherboard of the destination device 204, or may be otherwise incorporated within a peripheral device configured to interoperate with the destination device 204.

The processing unit 220 may include one or more processors, such as one or more microprocessors, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 220 may store instructions for the software in a suitable, non-transitory computer-readable storage medium (e.g., internal memory 221), and may execute the instructions in hardware using one or more processors to perform the techniques of this disclosure. Any of the foregoing (including hardware, software, a combination of hardware and software, etc.) may be considered to be one or more processors.

The content decoder 222 may be any processing unit configured to perform content decoding. In some examples, the content decoder 222 may be integrated into a motherboard of the destination device 204. The content decoder 222 may include one or more processors, such as one or more microprocessors, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the content decoder 222 may store instructions for the software in a suitable, non-transitory computer-readable storage medium (e.g., internal memory 223), and may execute the instructions in hardware using one or more processors to perform the techniques of this disclosure. Any of the foregoing (including hardware, software, a combination of hardware and software, etc.) may be considered to be one or more processors.

The communication interface 226 may include a receiver 228 and a transmitter 230. The receiver 228 may be configured to perform any receiving function described herein with respect to the destination device 204. For example, the receiver 228 may be configured to receive information from the source device 202, which may include encoded content, such as encoded graphical content produced or otherwise generated by the processing unit 206 and the content encoder 208 of the source device 202 (e.g., the graphical content is produced by the processing unit 206, which the content encoder 208 receives as input to produce or otherwise generate the encoded graphical content). As another example, the receiver 228 may be configured to receive position information from the source device 202, which may be encoded or unencoded (e.g., not encoded). In some examples, the destination device 204 may be configured to decode encoded graphical content received from the source device 202 in accordance with the techniques described herein. For example, the content decoder 222 may be configured to decode encoded graphical content to produce or otherwise generate decoded graphical content. The processing unit 220 may be configured to use the decoded graphical content to produce or otherwise generate one or more frames for presentment on the one or more displays 231. The transmitter 230 may be configured to perform any transmitting function described herein with respect to the destination device 204. For example, the transmitter 230 may be configured to transmit information to the source device 202, which may include a request for content. The receiver 228 and the transmitter 230 may be combined into a transceiver 232. In such examples, the transceiver 232 may be configured to perform any receiving function and/or transmitting function described with respect to the destination device 204.

The content encoder 208 and the content decoder 222 of the XR/MR system 200 represent examples of computing components (e.g., processing units) that may be configured to perform one or more techniques for encoding content and decoding content in accordance with various examples described in this disclosure, respectively. In some examples, the content encoder 208 and the content decoder 222 may be configured to operate in accordance with a content coding standard, such as a video coding standard, a display stream compression standard, or an image compression standard.

As shown in FIG. 2, the source device 202 may be configured to generate encoded content. Accordingly, the source device 202 may be referred to as a content encoding device or a content encoding apparatus. The destination device 204 may be configured to decode the encoded content generated by source device 202. Accordingly, the destination device 204 may be referred to as a content decoding device or a content decoding apparatus. In some examples, the source device 202 and the destination device 204 may be separate devices, as shown. In other examples, source device 202 and destination device 204 may be on or part of the same computing device. In either example, a graphics processing pipeline may be distributed between the two devices. For example, a single graphics processing pipeline may include a plurality of graphics processes. The graphics processing pipeline 207-1 may include one or more graphics processes of the plurality of graphics processes. Similarly, graphics processing pipeline 207-2 may include one or more processes graphics processes of the plurality of graphics processes. In this regard, the graphics processing pipeline 207-1 concatenated or otherwise followed by the graphics processing pipeline 207-2 may result in a full graphics processing pipeline. Otherwise described, the graphics processing pipeline 207-1 may be a partial graphics processing pipeline and the graphics processing pipeline 207-2 may be a partial graphics processing pipeline that, when combined, result in a distributed graphics processing pipeline.

In some examples, a graphics process performed in the graphics processing pipeline 207-1 may not be performed or otherwise repeated in the graphics processing pipeline 207-2. For example, the graphics processing pipeline 207-1 may include receiving first position information corresponding to a first orientation of a device. The graphics processing pipeline 207-1 may also include generating first graphical content based on the first position information. Additionally, the graphics processing pipeline 207-1 may include generating motion information for warping the first graphical content. The graphics processing pipeline 207-1 may further include encoding the first graphical content. Also, the graphics processing pipeline 207-1 may include providing the motion information and the encoded first graphical content. The graphics processing pipeline 207-2 may include providing first position information corresponding to a first orientation of a device. The graphics processing pipeline 207-2 may also include receiving encoded first graphical content generated based on the first position information. Further, the graphics processing pipeline 207-2 may include receiving motion information. The graphics processing pipeline 207-2 may also include decoding the encoded first graphical content to generate decoded first graphical content. Also, the graphics processing pipeline 207-2 may include warping the decoded first graphical content based on the motion information. By distributing the graphics processing pipeline between the source device 202 and the destination device 204, the destination device may be able to, in some examples, present graphical content that it otherwise would not be able to render; and, therefore, could not present. Other example benefits are described throughout this disclosure.

As described, a device, such as the source device 202 and/or the destination device 204, may refer to any device, apparatus, or system configured to perform one or more techniques described. For example, a device may be a server, a base station, user equipment, a client device, a station, an access point, a computer (e.g., a personal computer, a desktop computer, a laptop computer, a tablet computer, a computer workstation, or a mainframe computer), an end product, an apparatus, a phone, a smart phone, a server, a video game platform or console, a handheld device (e.g., a portable video game device or a personal digital assistant (PDA)), a wearable computing device (e.g., a smart watch, an augmented reality device, or a virtual reality device), a non-wearable device, an augmented reality device, a virtual reality device, a display (e.g., display device), a television, a television set-top box, an intermediate network device, a digital media player, a video streaming device, a content streaming device, an in-car computer, any mobile device, any device configured to generate graphical content, or any device configured to perform one or more techniques described herein.

Source device 202 may be configured to communicate with the destination device 204. For example, destination device 204 may be configured to receive encoded content from the source device 202. In some example, the communication coupling between the source device 202 and the destination device 204 is shown as link 234. Link 234 may comprise any type of medium or device capable of moving the encoded content from source device 202 to the destination device 204.

In the example of FIG. 2, link 234 may comprise a communication medium to enable the source device 202 to transmit encoded content to destination device 204 in real-time. The encoded content may be modulated according to a communication standard, such as a wireless communication protocol, and transmitted to destination device 204. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the source device 202 to the destination device 204. In other examples, link 234 may be a point-to-point connection between source device 202 and destination device 204, such as a wired or wireless display link connection (e.g., a high-definition multimedia interface (HDMI) link, a DisplayPort link, mobile industry processor interface (MIPI) display serial interface (DSI) link, or another link over which encoded content may traverse from the source device 202 to the destination device 204.

In another example, the link 234 may include a storage medium configured to store encoded content generated by the source device 202. In this example, the destination device 204 may be configured to access the storage medium. The storage medium may include a variety of locally-accessed data storage media such as Blu-ray discs, DVDs, CD-ROMs, flash memory, or other suitable digital storage media for storing encoded content.

In another example, the link 234 may include a server or another intermediate storage device configured to store encoded content generated by the source device 202. In this example, the destination device 204 may be configured to access encoded content stored at the server or other intermediate storage device. The server may be a type of server capable of storing encoded content and transmitting the encoded content to the destination device 204.

Devices described may be configured to communicate with each other, such as the source device 202 and the destination device 204. Communication may include the transmission and/or reception of information. The information may be carried in one or more messages. As an example, a first device in communication with a second device may be described as being communicatively coupled to or otherwise with the second device. For example, a client device and a server may be communicatively coupled. As another example, a server may be communicatively coupled to multiple client devices. As another example, any device described configured to perform one or more techniques of this disclosure may be communicatively coupled to one or more other devices configured to perform one or more techniques of this disclosure. In some examples, when communicatively coupled, two devices may be actively transmitting or receiving information, or may be configured to transmit or receive information. If not communicatively coupled, any two devices may be configured to communicatively couple with each other, such as in accordance with one or more communication protocols compliant with one or more communication standards. Reference to “any two devices” does not mean that only two devices may be configured to communicatively couple with each other; rather, any two devices are inclusive of more than two devices. For example, a first device may communicatively couple with a second device and the first device may communicatively couple with a third device. In such an example, the first device may be a server.

With reference to FIG. 2, the source device 202 may be described as being communicatively coupled to the destination device 204. In some examples, the term “communicatively coupled” may refer to a communication connection, which may be direct or indirect. The link 234 may, in some examples, represent a communication coupling between the source device 202 and the destination device 204. A communication connection may be wired and/or wireless. A wired connection may refer to a conductive path, a trace, or a physical medium (excluding wireless physical mediums) over which information may travel. A conductive path may refer to any conductor of any length, such as a conductive pad, a conductive via, a conductive plane, a conductive trace, or any conductive medium. A direct communication connection may refer to a connection in which no intermediary component resides between the two communicatively coupled components. An indirect communication connection may refer to a connection in which at least one intermediary component resides between the two communicatively coupled components. Two devices that are communicatively coupled may communicate with each other over one or more different types of networks (e.g., a wireless network and/or a wired network) in accordance with one or more communication protocols. In some examples, two devices that are communicatively coupled may associate with one another through an association process. In other examples, two devices that are communicatively coupled may communicate with each other without engaging in an association process. For example, a device, such as the source device 202, may be configured to unicast, broadcast, multicast, or otherwise transmit information (e.g., encoded content) to one or more other devices (e.g., one or more destination devices, which includes the destination device 204). The destination device 204 in this example may be described as being communicatively coupled with each of the one or more other devices. In some examples, a communication connection may enable the transmission and/or receipt of information. For example, a first device communicatively coupled to a second device may be configured to transmit information to the second device and/or receive information from the second device in accordance with the techniques of this disclosure. Similarly, the second device in this example may be configured to transmit information to the first device and/or receive information from the first device in accordance with the techniques of this disclosure. In some examples, the term “communicatively coupled” may refer to a temporary, intermittent, or permanent communication connection.

Any device described, such as the source device 202 and the destination device 204, may be configured to operate in accordance with one or more communication protocols. For example, the source device 202 may be configured to communicate with (e.g., receive information from and/or transmit information to) the destination device 204 using one or more communication protocols. In such an example, the source device 202 may be described as communicating with the destination device 204 over a connection. The connection may be compliant or otherwise be in accordance with a communication protocol. Similarly, the destination device 204 may be configured to communicate with (e.g., receive information from and/or transmit information to) the source device 202 using one or more communication protocols. In such an example, the destination device 204 may be described as communicating with the source device 202 over a connection. The connection may be compliant or otherwise be in accordance with a communication protocol.

The term “communication protocol” may refer to any communication protocol, such as a communication protocol compliant with a communication standard or the like. As used herein, the term “communication standard” may include any communication standard, such as a wireless communication standard and/or a wired communication standard. A wireless communication standard may correspond to a wireless network. As an example, a communication standard may include any wireless communication standard corresponding to a wireless personal area network (WPAN) standard, such as Bluetooth (e.g., IEEE 802.15), Bluetooth low energy (BLE) (e.g., IEEE 802.15.4). As another example, a communication standard may include any wireless communication standard corresponding to a wireless local area network (WLAN) standard, such as WI-FI (e.g., any 802.11 standard, such as 802.11a, 802.11b, 802.11c, 802.11n, or 802.11ax). As another example, a communication standard may include any wireless communication standard corresponding to a wireless wide area network (WWAN) standard, such as 3G, 4G, 4G LTE, 5G, or 6G.

With reference to FIG. 2, the content encoder 208 may be configured to encode graphical content. In some examples, the content encoder 208 may be configured to encode graphical content as one or more video frames of extended reality (XR), MR, or virtual reality (VR) content. When the content encoder 208 encodes content, the content encoder 208 may generate a bitstream. The bitstream may have a bit rate, such as bits/time unit, where time unit is any time unit, such as second or minute. The bitstream may include a sequence of bits that form a coded representation of the graphical content and associated data. To generate the bitstream, the content encoder 208 may be configured to perform encoding operations on pixel data, such as pixel data corresponding to a shaded texture atlas. For example, when the content encoder 208 performs encoding operations on image data (e.g., one or more blocks of a shaded texture atlas) provided as input to the content encoder 208, the content encoder 208 may generate a series of coded images and associated data. The associated data may include a set of coding parameters such as a quantization parameter (QP).

In the case of a virtual reality (VR) headset that covers the user's eyes, the user is blind when the headset is not booted up, or undergoes a system crash, warm reset, or user initiated hard reset. This state of blindness is not suitable in mixed reality use cases and can be dangerously unsafe for the user. For example, a user wearing a VR head set in mixed reality mode with video see through (VST) may be walking on the street when the VR device undergoes a crash, warm reset, or user initiated hard reset. In such an example, the crash, warm reset, or user initiated hard reset makes the user blind to the real environment, which can be life threatening. Safety is also an issue when the user decides to first wear the VR device and then subsequently power on the device. Aspects of the present disclosure more quickly enable a camera in the VST display path or allow the camera to be always enabled. The improved camera availability makes the VR headset commercially safe for mixed reality (MR) use cases.

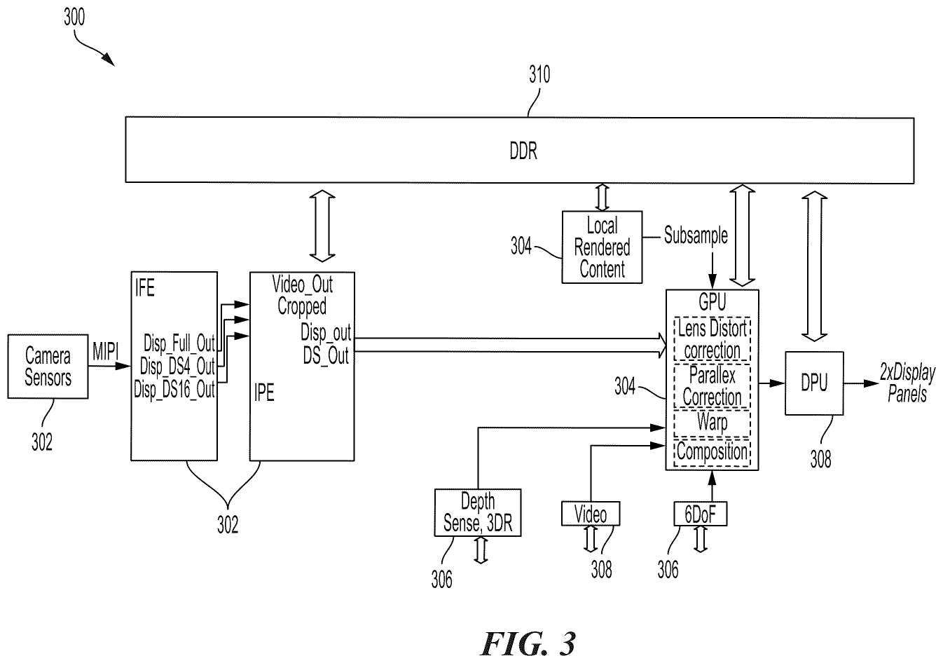

FIG. 3 is a block diagram illustrating video see through (VST) components, in accordance with various aspects of the present disclosure. As seen in FIG. 3, booting up a VST system 300 enables camera components 302 (including camera sensors, an image front-end (IFE), and image processing engine (IPE)), a graphics processing unit (GPU) (including local rendered content) 304, a video accelerator (including a six degrees of freedom (6DoF) block and a depth sense three-dimensional reconstruction (3DR) block) 306, and video and display processing unit (DPU) cores 308. Double data rate (DDR) memory 310 stores the camera output. The GPU 304 and DPU 308 fetch input from the DDR memory 310.

Due to the amount of time specified to boot up these systems, VR headsets are limited in the sense that the headsets blind the users in case of reset scenarios. These scenarios include first time cold boot and system crash resets. To enable video see through (VST), the system needs to boot up to high-level operating system (HLOS) for configuring and enabling the camera, display, and graphics. This takes several seconds, during which the user will be blind to the real world. If a software crash or reboot happens during mixed reality usage, danger may exist based on the user's environment, for example, when crossing a street or climbing stairs. The problem worsens if dual systems-on-a-chip (SoCs) are used, as boot time is extended.

A constant stream of the real world to the user through both the display and video see through (VST) camera is needed. According to aspects of the present disclosure, the constant stream can be achieved by booting the VST hardware subsystem quickly or by keeping the VST hardware subsystem always on.

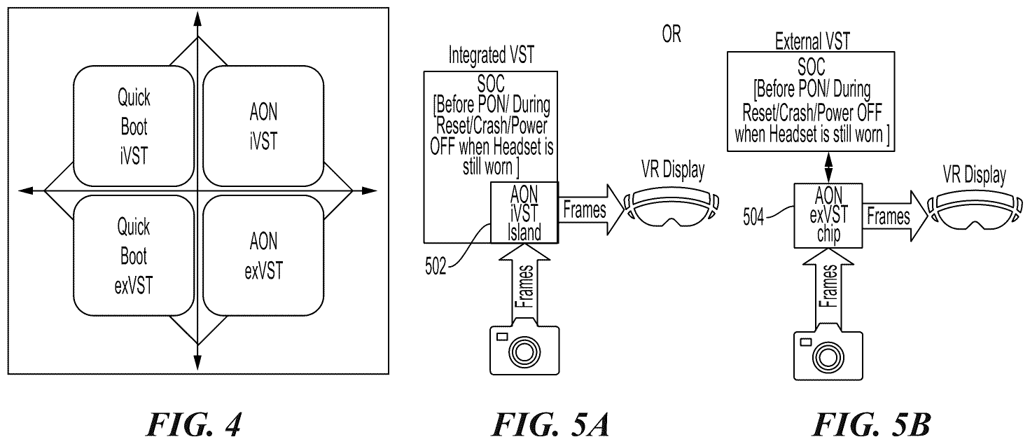

FIG. 4 is a diagram illustrating solution coverage, in accordance with various aspects of the present disclosure. As seen in FIG. 4, four solutions are presented: quick boot integrated video see through (iVST), quick boot external VST (exVST), always on (AON) iVST, and AON exVST.

With quick boot, the VST subsystem/pipeline is enabled early in the boot process, for example, within approximately 300 ms of a SoC reset or crash. Because the human eye blink time is approximately 300 ms, booting within 300 ms practically eliminates blind time for the VR user, ensuring user safety.

With always on (AON) solutions, the VST hardware subsystem always remains on, despite the rest of the system going through a reset.

Integrated or external VST solutions can both selectively utilize quick boot or always on (AON) methodologies.

FIGS. 5A and 5B are block diagrams illustrating integrated and external VST configurations, respectively, in accordance with various aspects of the present disclosure. To enable VST quickly, the VST block uses fewer cores. Hence, the iVST and exVST solutions propose a separate dedicated hardware block for VST processing. The dedicated VST block 502 can be integrated into the main SoC as with the integrated VST (iVST) solution seen in FIG. 5A. Alternatively, the VST block 504 can be a standalone chip, called external VST (exVST), that is separate from the SoC, as seen in FIG. 5B.

VST should operate with low power to conserve battery in case of the always on solution. Also, the size of the dedicated VST block should be kept small. The small size and low power may be achieved by limiting the camera resolution, the frames per second (FPS), and the display resolution. The smaller size and low power may also be achieved by using a six degrees of freedom (6DoF) camera instead of a higher resolution camera (e.g., an RGB camera) for monochrome VST. These modifications create an improved low power pipeline from the camera to the display.

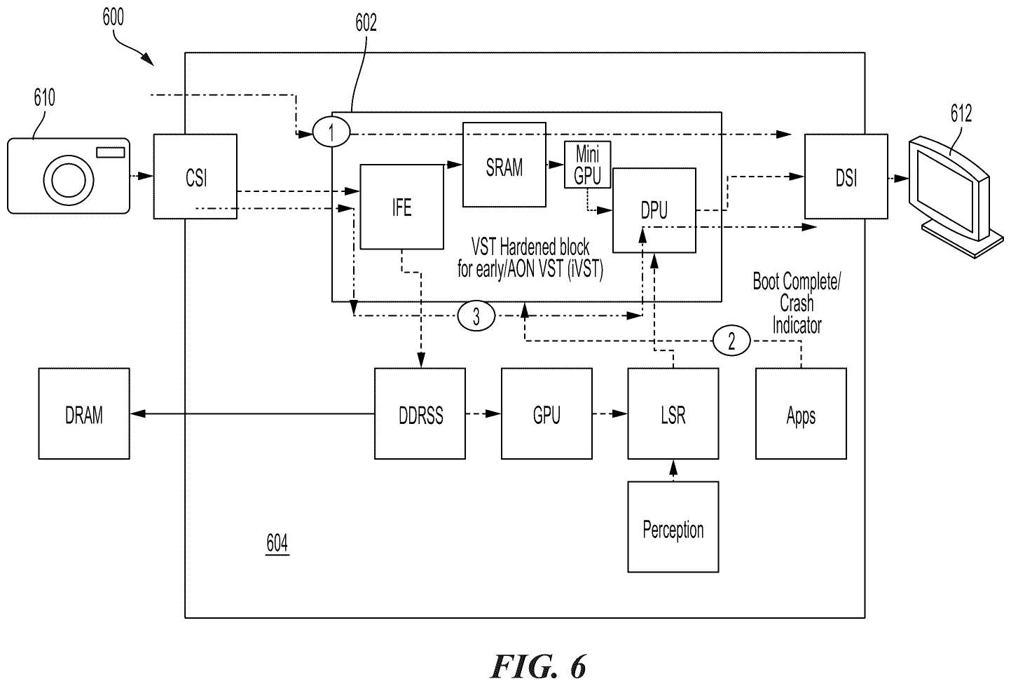

FIG. 6 is a block diagram illustrating an integrated video see through (iVST) system 600 for early on VST operation or always on VST operation, in accordance with various aspects of the present disclosure. As seen in the example of FIG. 6, an iVST block 602 is a hardened block integrated with a main SoC 604 for the early VST feature or for the always on VST feature. The iVST block 602 has a dedicated domain including a power rail for the core and logic, VST_CX rail, and a power rail for static random access memory (SRAM), VST_MX rail. The iVST block 602 includes a camera IFE, a DPU, SRAM, and a lower featured GPU (mini GPU). The mini GPU performs corrections for low quality VST operation. Not all components of the iVST block 602 are fully dedicated blocks. For example, the camera IFE and the DPU, which are pulled in from the SoC 604, are repurposed for mission mode operation (e.g., normal operation). Hence, the iVST block 602 interfaces to other hardware blocks in the SoC 604 for usage of the hardware blocks in the iVST block 602 for mission mode operation. The hardware blocks in the SoC 604 outside of the iVST block 602 include a camera serial interface (CSI), a double data rate memory subsystem (DDRSS), the GPU, a late stage reproduction (LSR) block, a perception block, applications (apps), and a display serial interface (DSI). The CSI and DSI blocks are outside the iVST, but are resources shared with the main SoC 604. In the iVST mode when rest of the SoC 604 is crashed or powered off, the CSI and DSI are powered on along with the iVST hardware block 602 to enable the camera and display path.

Until the SoC 604 boots up, the dedicated power rails of the iVST block 602 and the interfaces between the iVST block 602 and the SoC 604 are isolated from the SoC 604. The separate rails of the iVST block 602 and isolated interfaces enable the iVST block 602 to boot in parallel with the rest of the SoC 604 so that VST operation is available quickly, for example, as early as approximately 300 ms. The separate rails and isolated interfaces also help keep the iVST block 602 always on while the rest of the SoC 604 resets. Thus, the iVST block 602 can reset during a crash for a clean start or the iVST block 602 can stay enabled as an always on block during a crash.

Applications (apps) may instruct the iVST block 602 to switch a display path to a regular data flow path (e.g., including the DDRSS and the full size GPU, etc.) using a boot complete indicator signal, or switch the path to the iVST block 602 using a crash indicator signal. For example, reference number 2 in FIG. 6 shows an application (apps) indicating a crash or indicating that the boot is complete. In response to a crash indicator, path number 1 shows the iVST block 602 enabled (e.g., from a camera 610 to the CSI, IFE, SRAM, mini GPU, DPU, and DSI to a display 612). In response to a boot complete indicator, path number 3 shows mission mode operation from a camera 610 through the CSI, IFE, DDRSS, GPU, LSR, DPU, and DSI to the display 612 when high quality VST operations resume.

Always on or early VST operation uses on-chip static random access memory (SRAM) instead of DRAM to limit the boot up or enable time. Additionally, the SRAM in the iVST block 602 can be made accessible as a last level cache (LLC) during mission mode operation.

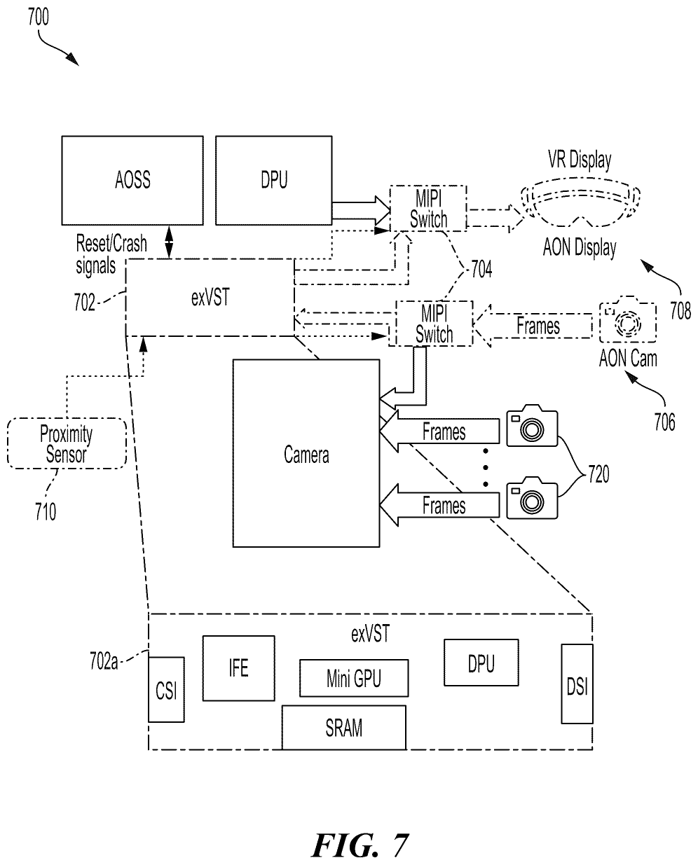

FIG. 7 is a block diagram illustrating an external video see through (exVST) system 700 for early on VST operation or always on VST operation, in accordance with various aspects of the present disclosure. As seen in the example of FIG. 7, an external VST (ExVST) coprocessor 702 operates in a path that is independent of a path for a main SoC, which includes a camera, DPU, and always on subsystem (AOSS). The block labeled ‘Camera’ includes the IFE, IPEs, etc. within the SoC. The AOSS, DPU and Camera blocks are within the SoC. The exVST coprocessor 702 sits outside the SoC in a separate chip but shares the same connections as the SoC through switches, such as mobile industry processor interface (MIPI) switches 704.

The exVST path can be enabled or disabled based on the main SoC status shared through a reset or crash signal, for example, in sideband signaling, such as general purpose input/output (GPIO) signaling. For example, when the SoC crashes, the AOSS signals the crash indication to the exVST coprocessor 702 through an internal GPIO signal to enable the exVST coprocessor 702. To re-use the same camera and display hardware, switches 704 are deployed to control the VST path. The exVST coprocessor 702 controls the switches 704 to change the VST path between a main SoC path and an exVST path. The exVST path flows from an always on camera 706 to the exVST coprocessor 702 and to an always on display 708, via the switches 704. The main SoC path flows from high resolution cameras 720 to the DPU and VR display, without the exVST coprocessor 702.

An optional proximity sensor 710 may be enabled through the exVST coprocessor 702 to detect the presence of a head. That is, the proximity sensor 710 may prevent the exVST coprocessor 702 from running if a user is not wearing the VR headset.

The exVST coprocessor cores are loaded with camera and display settings in accordance with original equipment manufacturer (OEM) specifications. The OEM specifications may be enabled through flash memory or read only memory (ROM). The exVST coprocessor 702 can remain powered on through the crash scenarios or can be booted early within approximately 300 msec when a crash reset happens. Early boot up can also provide early VST functionality to a user while the main SoC is still booting up. The VST path switches to the main SoC path once the main SoC finishes resetting.

An enlarged view 702a of the exVST coprocessor 702 shows the IFE, DPU, mini GPU, SRAM, and two interfaces: CSI and DSI. The internal SRAM avoids the time taken to enable DDR memory. The exVST coprocessor 702 enables the always on camera 706, the MiniGPU, and the display 708 to operate at a minimal suitable configuration with the SRAM.

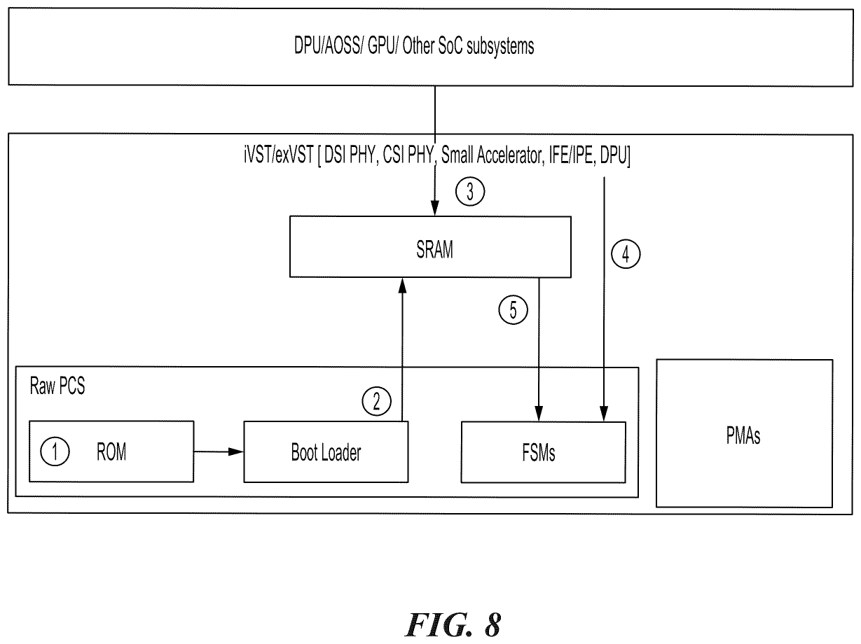

FIG. 8 is a block diagram illustrating a read only memory (ROM) boot loader for iVST and exVST systems operating with an early on VST feature, in accordance with various aspects of the present disclosure. As seen in the example of FIG. 8, a time 1, the iVST or exVST stores firmware for configuration of the blocks inside the core. Also, pre-optimized and pre-validated firmware code to execute calibration and adaptation algorithms are stored in ROM. At time 2, a boot loader inside the iVST or exVST loads the code from ROM to internal SRAM. At time 3, software on the host side downloads new firmware to the SRAM via an on-chip interface at the iVST block boundary or interface to the exVST, if necessary, in other words, to overwrite the firmware stored in the ROM. At time 4, software on the host side triggers finite state machines (FSMs) in the raw physical coding layer (PCS) to start execution. At time 5, FSMs in the raw PCS start to execute the code from the SRAM.

Physical memory attributes (PMAs) represent static permissions assigned to regions of the device memory map. The PMAs are employed for iVST and exVST operations in default mode or a minimal configuration mode as the operations are expected to run on pre-optimized firmware that sits in small read only memory (ROM). The host in this context is the operating system software, such as a high level operating system (HLOS). The iVST and exVST functions are capable of working on their own with their own firmware to be loaded from ROM to static random access memory (SRAM). If necessary for an upgrade or change, the host (e.g., the HLOS) can write new firmware to SRAM overriding the default firmware in the ROM.

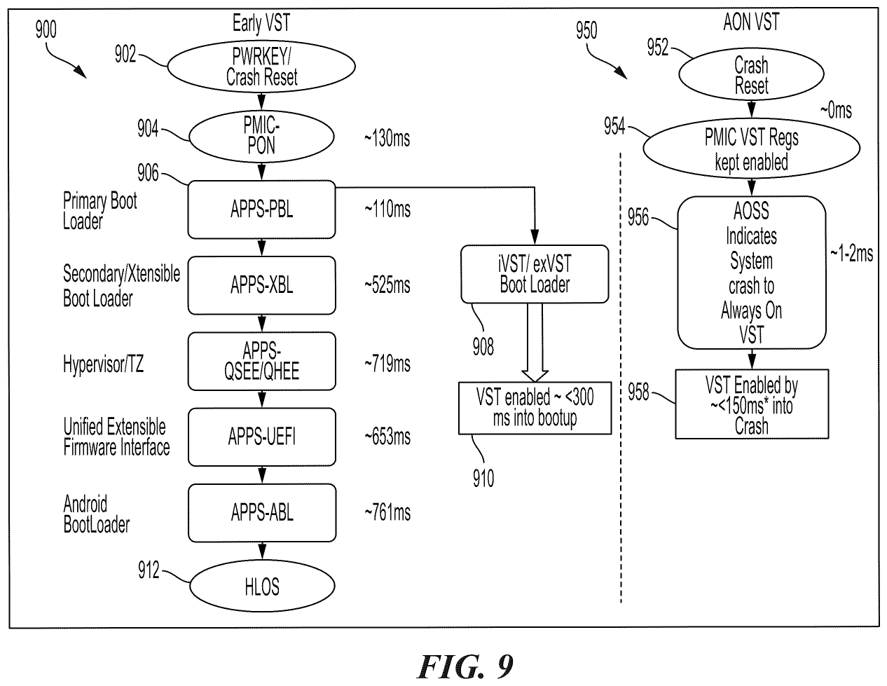

FIG. 9 is a flow diagram illustrating VST processing for early on VST and always on VST features, in accordance with various aspects of the present disclosure. For early on VST operation shown in a leftmost diagram 900, after a power key press or crash reset at block 902, a power management integrated circuit (PMIC) powers on at block 904. The PMIC power on may take approximately 130 ms. At block 906, a primary boot loader executes. Next, at block 908, an iVST or an exVST boot loader executes, as discussed with respect to FIG. 8. Finally, a VST operation is enabled at block 910, less than 300 ms into the boot up process. At block 912, a high-level operating system (HLOS) of a main SoC runs, after a secondary/extensible boot loader, a hypervisor, a unified extensible firmware interface, and an ANDROID boot loader execute, which together take around 8 seconds. Thus, it can be seen that the proposed early on solution is faster than existing solutions.

For always on VST operation shown in a rightmost diagram 950, after a crash reset at block 952, PMIC VST registers remain enabled at block 954. At block 956, an AOSS indicates a system crash to an always on VST coprocessor, which may take approximately 1 to 2 ms. At block 958, a VST is enabled less than 150 ms after the crash event. Thus, it can be seen that the proposed always on solution is also faster than existing solutions.

Time needed to recover from power loss events, such as hardware and software resets, may allow a mishap to happen. The proposed solutions ensure a user is not practically blind when a headset is worn, even during initial power on or subsequent restarts. During a system crash or reset, a user is suddenly blinded with no visual stream to the real world. The new solutions avoid the blindness, enabling the user to see the real world as soon as the headset is worn. The always on VST feature enables a user to continue seeing the real world when the headset is still worn as long as enough power is available to power the VST block.

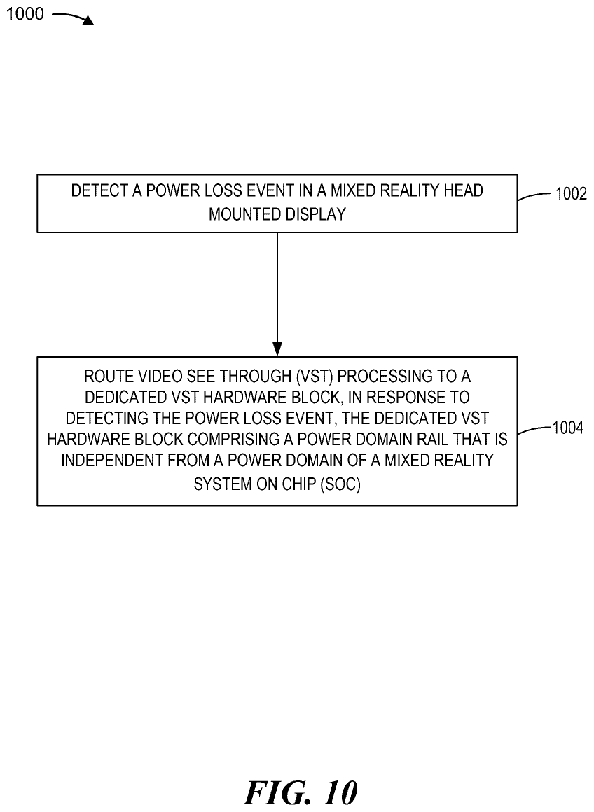

FIG. 10 is a flowchart illustrating VST processing, in accordance with various aspects of the present disclosure. As shown in FIG. 10, in some aspects, the process 1000 may include detecting a power loss event in a mixed reality head mounted display (block 1002).

In some aspects, the process 1000 may include routing video see through (VST) processing to a dedicated VST hardware block, in response to detecting the power loss event, the dedicated VST hardware block comprising a power domain rail that is independent from a power domain of a mixed reality system on chip (SoC) (block 1004). In some aspects, the dedicated VST hardware block is integrated into the mixed reality SoC. In other aspects, the dedicated VST hardware block is external to the mixed reality SoC.

### EXAMPLE ASPECTS

### Aspect 1

A computing method, comprising: detecting a power loss event in a mixed reality head mounted display; and routing video see through (VST) processing to a dedicated VST hardware block, in response to detecting the power loss event, the dedicated VST hardware block comprising a power domain rail that is independent from a power domain of a mixed reality system on chip (SoC).

### Aspect 2

The method of Aspect 1, in which the dedicated VST hardware block is integrated into the mixed reality SoC.

### Aspect 3

The method of Aspect 1 or 2, further comprising booting the dedicated VST hardware block in parallel with booting the mixed reality SoC after detecting the power loss event.

### Aspect 4

The method of Aspect 1, in which the dedicated VST hardware block is external to the mixed reality SoC.

### Aspect 5

The method of any of the preceding Aspects, further comprising processing VST signals with the dedicated hardware VST block at a lower camera resolution and/or frames per second than mixed reality SoC processing.

### Aspect 6

The method of any of the preceding Aspects, further comprising processing VST signals in monochrome with the dedicated hardware VST block.

### Aspect 7

The method of any of the preceding Aspects, further comprising routing VST processing to the mixed reality SoC in response to receiving a boot complete indicator signal.

### Aspect 8

The method of any of the preceding Aspects, further comprising communicating with on-chip static random access memory (SRAM) when processing VST signals with the dedicated VST hardware block.

### Aspect 9

The method of any of the preceding Aspects, further comprising loading firmware from read only memory (ROM) for configuring the dedicated VST hardware block.

### Aspect 10

The method of any of the preceding Aspects, further comprising routing VST processing to the mixed reality SoC in response to not sensing proximity of a user of the head mounted display.

### Aspect 11

An apparatus, comprising: at least one memory; and at least one processor coupled to the at least one memory, the at least one processor configured: to detect a power loss event in a mixed reality head mounted display; and to route video see through (VST) processing to a dedicated VST hardware block, in response to detecting the power loss event, the dedicated VST hardware block comprising a power domain rail that is independent from a power domain of a mixed reality system on chip (SoC).

### Aspect 12

The apparatus of Aspect 11, in which the dedicated VST hardware block is integrated into the mixed reality SoC.

### Aspect 13

The apparatus of Aspect 11 or 12, in which the at least one processor is further configured to boot the dedicated VST hardware block in parallel with booting the mixed reality SoC after detecting the power loss event.

### Aspect 14

The apparatus of any of the Aspect 11, in which the dedicated VST hardware block is external to the mixed reality SoC.

### Aspect 15

The apparatus of any of the Aspects 11-14, in which the at least one processor is further configured to process VST signals with the dedicated hardware VST block at a lower camera resolution and/or frames per second than mixed reality SoC processing.

### Aspect 16

The apparatus of any of the Aspects 11-15, in which the at least one processor is further configured to process VST signals in monochrome with the dedicated hardware VST block.

### Aspect 17

The apparatus of any of the Aspects 11-16, in which the at least one processor is further configured to rout VST processing to the mixed reality SoC in response to receiving a boot complete indicator signal.

### Aspect 18

The apparatus of any of the Aspects 11-17, in which the at least one processor is further configured to communicate with on-chip static random access memory (SRAM) when processing VST signals with the dedicated VST hardware block.

### Aspect 19

The apparatus of any of the Aspects 11-18, in which the at least one processor is further configured to load firmware from read only memory (ROM) for configuring the dedicated VST hardware block.

### Aspect 20

The apparatus of any of the Aspects 11-19, in which the at least one processor is further configured to comprising route VST processing to the mixed reality SoC in response to not sensing proximity of a user of the head mounted display.

In accordance with this disclosure, the term “or” may be interrupted as “and/or” where context does not dictate otherwise. Additionally, while phrases such as “one or more” or “at least one” or the like may have been used for some features disclosed herein but not others; the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage or other magnetic storage devices, Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules or units are described in this disclosure to emphasize functional aspects of devices configured to perform the disclosed techniques, but do not necessarily require realization by different hardware units. Rather, as described above, various units may be combined in any hardware unit or provided by a collection of interoperative hardware units, including one or more processors as described above, in conjunction with suitable software and/or firmware.

Various examples have been described. These and other examples are within the scope of the following claims.

What is claimed is:

1. A computing method, comprising:
detecting a power loss event in a mixed reality head mounted display; and
routing video see through (VST) processing to a dedicated VST hardware block, in response to detecting the power loss event, the dedicated VST hardware block comprising a power domain rail that is independent from a power domain of a mixed reality system on chip (SoC).

2. The method of claim 1, in which the dedicated VST hardware block is integrated into the mixed reality SoC.

3. The method of claim 2, further comprising booting the dedicated VST hardware block in parallel with booting the mixed reality SoC after detecting the power loss event.

4. The method of claim 1, in which the dedicated VST hardware block is external to the mixed reality SoC.

5. The method of claim 1, further comprising processing VST signals with the dedicated hardware VST block at a lower camera resolution and/or frames per second than mixed reality SoC processing.

6. The method of claim 1, further comprising processing VST signals in monochrome with the dedicated hardware VST block.

7. The method of claim 1, further comprising routing VST processing to the mixed reality SoC in response to receiving a boot complete indicator signal.

8. The method of claim 1, further comprising communicating with on-chip static random access memory (SRAM) when processing VST signals with the dedicated VST hardware block.

9. The method of claim 1, further comprising loading firmware from read only memory (ROM) for configuring the dedicated VST hardware block.

10. The method of claim 1, further comprising routing VST processing to the mixed reality SoC in response to not sensing proximity of a user of the head mounted display.

11. An apparatus, comprising:
at least one memo and
at least one processor coupled to the at least one memory, the at least one processor configured:
to detect a power loss event in a mixed reality head mounted display; and
to route video see through (VST) processing to a dedicated VST hardware block, in response to detecting the power loss event, the dedicated VST hardware block comprising a power domain rail that is independent from a power domain of a mixed reality system on chip (SoC).

12. The apparatus of claim 11, in which the dedicated VST hardware block is integrated into the mixed reality SoC.

13. The apparatus of claim 12, in which the at least one processor is further configured to boot the dedicated VST hardware block in parallel with booting the mixed reality SoC after detecting the power loss event.

14. The apparatus of claim 11, in which the dedicated VST hardware block is external to the mixed reality SoC.

15. The apparatus of claim 11, in which the at least one processor is further configured to process VST signals with the dedicated hardware VST block at a lower camera resolution and/or frames per second than mixed reality SoC processing.

16. The apparatus of claim 11, in which the at least one processor is further configured to process VST signals in monochrome with the dedicated hardware VST block.

17. The apparatus of claim 11, in which the at least one processor is further configured to rout VST processing to the mixed reality SoC in response to receiving a boot complete indicator signal.

18. The apparatus of claim 11, in which the at least one processor is further configured to communicate with on-chip static random access memory (SRAM) when processing VST signals with the dedicated VST hardware block.

19. The apparatus of claim 11, in which the at least one processor is further configured to load firmware from read only memory (ROM) for configuring the dedicated VST hardware block.

20. The apparatus of claim 11, in which the at least one processor is further configured to comprising route VST processing to the mixed reality SoC in response to not sensing proximity of a user of the head mounted display.
